(19) United States
(12) Patent Application Publication
(10) Pub. No.: US 2008/0212145 A1
(43) Pub. Date: Sep. 4, 2008

(54) IMAGE FORMING APPARATUS FOR VISUALLY IMPAIRED PEOPLE AND IMAGE FORMING METHOD OF THE IMAGE FORMING APPARATUS

(75) Inventors: Hong-seock KIM, Seoul (KR); Jong-woo Park, Seoul (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/030,426

(22) Filed: Feb. 13, 2008

(30) Foreign Application Priority Data
Feb. 14, 2007 (KR) 2007-15591

(51) Int. Cl. H04N 1/00

(52) U.S. Cl. 358/434

(57) ABSTRACT

An image forming method of an image forming apparatus includes generating voice data based on image data, which will be transmitted, if a voice attaching signal is input, and transmitting at least one of the image data and the voice data to an external device, so that a visually impaired person can identify the image data when receiving and transmitting the image data.

### CROSS-REFERENCE TO RELATED APPLICATIONS

This application claims priority from Korean Patent Application No. 10-2007-0015591, filed on Feb. 14, 2007 in the Korean Intellectual Property Office, the disclosure of which is incorporated herein in its entirety by reference.

### BACKGROUND OF THE INVENTION

1. Field of the Invention

The present general inventive concept relates to an image forming apparatus, and more particularly, to an image forming apparatus capable of transmitting and/or receiving voice data along with image data during fax-transmission and/or reception, and an image forming method of the image forming apparatus.

2. Description of the Related Art

In general, an image forming apparatus prints image data on a printing medium according to a printing signal of a host apparatus. The image forming apparatus includes a scanning function for scanning an original document and generating image data, an e-mail transmitting function for transmitting the image data through an e-mail server to a predetermined recipient's e-mail, and a fax-transmission function for transmitting an image data through a modem to an external fax device.

Here, the conventional image forming apparatus scans an original document, generates image data and the generated image data is transmitted to a reception fax machine if the image data is transmitted to an external device by fax. However, the conventional image forming apparatus does not include any means by which a visually impaired person can identify the image data in the case that a recipient of the image data is a visually impaired person. Accordingly, the visually impaired person was not able to identify whether or not the image data received through the image forming apparatus is the image data which the person wanted to receive.

Also, the conventional image forming apparatus has an inconvenience unable to identify whether the image data generated through a scanning process corresponds to the document which the visually impaired person wants to transmit in the case that the user who wants to fax-transmit the document is a visually impaired person.

### SUMMARY OF THE INVENTION

Additional aspects of the present general inventive concept will be set forth in part in the description which follows and, in part, will be obvious from the description, or may be learned by practice of the present general inventive concept.

The present general inventive concept provides an image forming apparatus and an image forming method of an image forming apparatus capable of receiving and/or transmitting voice data so that a visually impaired person can identify the image data when receiving and/or transmitting the image data.

The foregoing and/or other aspects utilities of the present general inventive concept can be achieved by providing an image forming method of an image forming apparatus, the method including generating voice data based on image data, which will be transmitted, if a voice attaching signal is input, and transmitting at least one of the image data and the voice data to an external device.

The image forming method may further include scanning a document to generate the image data.

The image forming method may further include outputting the generated voice data, and receiving an input about whether to transmit the image data corresponding to the voice data.

The image forming method may further include transmitting only the voice data to the external device through a modem, and receiving an input from the external device about whether the external device receives the image data corresponding to the voice data.

The foregoing and/or other aspects utilities of the present general inventive concept can also be achieved by providing an image forming method of an image forming apparatus, the method including outputting voice data if the voice data is received from an external device, receiving an input about whether to receive image data corresponding to the voice data, receiving the image data if a reception approval signal for the image data is input, and outputting the image data to a printing medium.

The foregoing and/or other aspects utilities of the present general inventive concept can also be achieved by providing an image forming method of an image forming apparatus, the method including generating voice data based on image data received from an external device if an voice output signal is input, outputting the generated voice data and receiving an input about whether to output the image data, and outputting the image data to a printing medium if an output approval signal for the image data is input.

The foregoing and/or other aspects utilities of the present general inventive concept can also be achieved by providing an image forming apparatus including a voice data generating unit to generate voice data based on image data, a voice outputting unit to output the voice data, an image forming unit to output the image data to a printing medium, a communicating unit to communicate with an external device to receive and/or transmit at least one of the image data and the voice data, and a controller to generate the voice data based on the image data when a voice attaching signal is applied, and to control the communicating unit to transmit at least one of the image data and the voice data to the external device.

The image forming apparatus may further includes a scanning unit which scans a document and generates image data, and the image data may include one of data generated by the scanning unit and data received through the communicating unit.

The voice data generating unit may convert a text or at least partial area of an image, which is contained in the image data, into the voice data.

The voice data generating unit may include a character identifying unit to identify the text or the image, and a text-voice converting unit to convert the text or the image identified in the character identifying unit into the voice data.

The document may include the information storing tag containing voice information, and the voice data generating unit may read the information storing tag to generate the voice data.

The information storing tag may be provided as at least one of an RFID tag, a smart chip and an EPROM.

The controller may control the voice outputting unit to output the voice data generated by the voice data generating unit, and receive an input about whether to transmit the image data corresponding to the voice data.

The communicating unit may include a modem, and the controller may transmit the voice data to the external device through the modem and receives an input from the external device about whether the external device receives the image data corresponding to the voice data.

The controller may control the communicating unit to transmit the image data and the voice data to the external device when receiving a transmission approval signal for the image data.

The controller may output the voice data through the voice outputting unit when receives the voice data from the external device, and receive an input about whether to receive the image data corresponding to the voice data.

When the image data is received from the external device, the controller may control the voice data generating unit and the voice outputting unit to generate the voice data based on the image data and to output the voice data, respectively.

The controller may control the image forming unit to output the received image data to the printing medium.

The foregoing and/or other aspects utilities of the present general inventive concept can also be achieved by providing a computer-readable medium to contain computer-readable codes as a program to execute a method of an image forming apparatus, the method including generating voice data based on image data according to a voice attaching signal, and transmitting at least one of the image data and the voice data to an external device.

### BRIEF DESCRIPTION OF THE DRAWINGS

The above and/or other aspects of the present general inventive concept will become apparent and more readily appreciated from the following description of the exemplary embodiments, taken in conjunction with the accompanying drawings, in which:

FIG. 1 is a block diagram illustrating an image forming apparatus according to an embodiment of the present general inventive concept;

FIG. 2 is an exemplary view illustrating a configuration of a document according to an embodiment of the present general inventive concept;

FIG. 3 is a flow diagram illustrating a fax transmitting method of an image forming apparatus according to an embodiment of the present general inventive concept;

FIG. 4 is a flow diagram illustrating a fax transmitting method of an image forming apparatus according to an embodiment of the present general inventive concept;

FIG. 5 is a flow diagram illustrating a fax receiving method of an image forming apparatus according to an embodiment of the present general inventive concept; and

FIG. 6 is a flow diagram illustrating a fax receiving method of an image forming apparatus according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below so as to explain the present general inventive concept by referring to the figures.

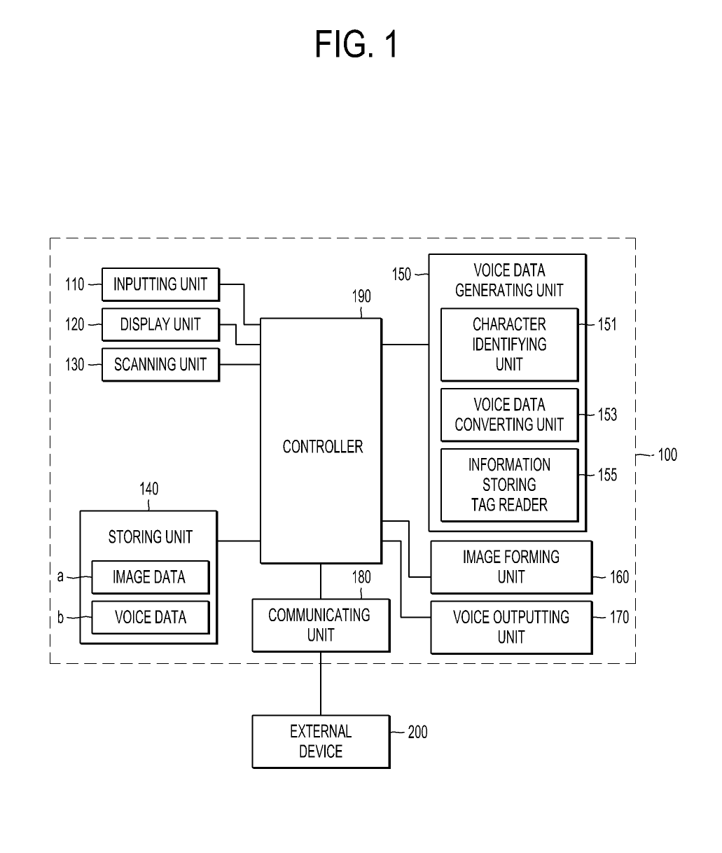

FIG. 1 is a block diagram illustrating a configuration of an image forming apparatus 100 according to an embodiment of the present general inventive concept. As illustrated in FIG. 1, the image forming apparatus 100 according to the present embodiment includes an inputting unit 110 which receives a signal input from a user, a display unit 120 which displays an operating state of the image forming apparatus 100, a scanning unit 130 which scans an original document and generates image data, an information storing unit 140 which stores image data a and voice data b respectively generated in the scanning unit 130 and a voice data generating unit 150, which converts voice converting information included in the original document into the voice data b, an image forming unit 160 which outputs the image data a onto a printing medium, a voice outputting unit 170 which outputs the voice data b, a communicating unit 180 which transmits and/or receives the image data a and the voice data b to and/or from an external device, and a controller 190.

The inputting unit 110 receives the input signal by user. The inputting unit 110 includes a plurality of inputting panels to input a character and a number. Also, the inputting unit 110 may include a hot key to indicate at least one of a plurality of functions. The plurality of functions may include “fax transmission,” “scanning,” “e-mail transmission,” “outputting,” etc., to be performed in the image forming apparatus 100. Here, the inputting unit 110 according to an exemplary embodiment of the present general inventive concept may include the hot key which receives an additional function and is written as “fax transmission for a visually impaired person” or “voice attachment” in a case that the user selects “fax transmission.”

Also, the inputting unit 110 may be separately provided to have a first input unit when a transmitter may be a visually impaired person and a second input unit when a recipient may be a visually impaired person according to the hot key of written by “fax transmission for a visually impaired person.” It is possible that the hot key may have one or more cells having raised dots (or Braille) on a surface of the hot key to enable the user to easily identify the hot key by touching the raised dots if the user is the visually impaired person. The inputting unit 110 transmits the input signal applied by the user to the controller 190.

The display unit 120 displays an operating state of the image forming apparatus 100 according to a control signal of the controller 190 so that the user can identify the operating state thereof. The display unit 120 is provided as a thin-film panel such as an LCD, and TFT to display the operating state of the image forming apparatus 100 and a guide message to guide or represent the operation state with character or visual image. Also, the display unit 120 displays whether the image data a has been transmitted and the recipient has received the transmitted image data a in a case that the user selects a fax-transmission function. Meanwhile, the display unit 120 can output sounds to guide or represent that a procedure for the fax transmission is performed in the voice outputting unit 170 in a case that the recipient selects “a fax-transmission function for a visually impaired person” or “a voice attachment function.”

The scanning unit 130 scans the original document and generates the image data a. The scanning unit 130 scans light onto the original document loaded on a stage glass (not illustrated) and converts the amount of light reflected from the original document into a digital signal to generate the image data a. Here, the image data a is generated as an image file such as X.jpg, X.bmp, and X.tif.

The voice data generating unit 150 generates voice data b on the basis of the image data a generated in the scanning unit 130 according to a control signal of the controller 190. The voice data b may be generate to correspond to a predetermined area of one or more characters or one or more images included in the image data a, or may be generated to correspond to an information storing tag included in the image data a.

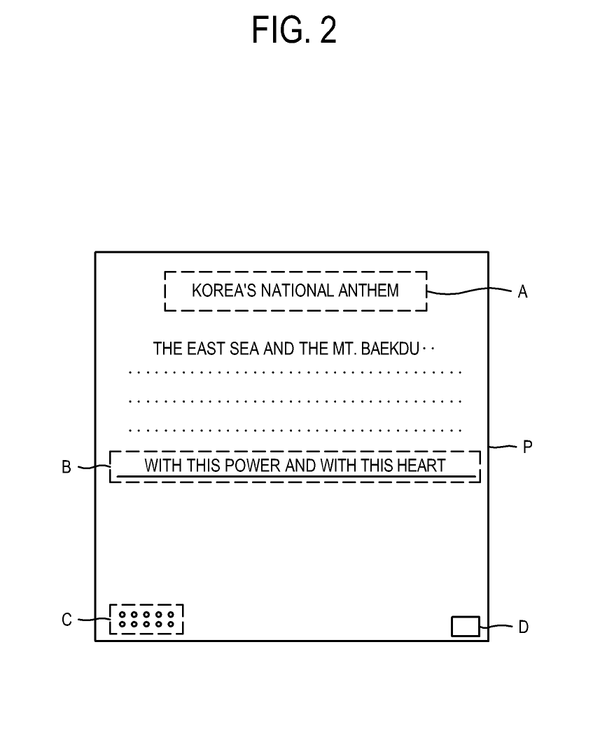

For example, in a case of an original document P of FIG. 2, the voice data b may be converted from a phrase or a sentence A written in a front portion of the original document in a feeding direction or a scanning direction of the original document. The voice data b may be provided as a title of the original document. Also, the voice data b may be converted from a phrase or a sentence B underlined, marked with a predetermined symbol or character, written in a different color from colors of other areas, or being bold. The voice data b can represent an important word or sentence of the original document. Also, the voice data b may be converted from raised dots (or Braille) C for the visually impaired person.

Meanwhile, the original document may include information storing tag D containing information. The information may be voice information to correspond to the voice data b. In this case, the information storing tag D may be a radio frequency identification (RFID) tag which transmits and receives the information to and from an information storing tag reader 155 of the voice data generating unit 150 through a wireless radio frequency, a smart chip which stores the information, or an erasable and programmable-read only memory (EP-ROM) which can electrically store the information. The information storing tag D may store information having the same contents as the image data a included in the original document, or information obtained by briefly summarizing the image data a.

Here, the voice data generating unit 150 may receive a user's selection related to a determination of which portion of the document will be used to form the voice data b. In a case that there is no user's selection, the voice data generating unit 150 may generate voice data b according to a default value, that is, the voice data b may be generated from one or two sentences including a title of the original document. The default value may be a value to correspond to another portion of the original document, for example, the phrase or sentence B, the raised dots (Braille) C, or the information storing tag D. The information is converted into the voice data b. Accordingly, the scanned image includes one or more portions to contain the information to be converted to form the voice data b.

The voice data generating unit 150 generates the voice data b based on the image data a as described above. The voice data generating unit 150 may include a character identifying unit 151 which identifies a character included in the image data a, and a text-voice data converting unit 153 which converts the identified character into a voice if the voice converting information is a character or images A, B, and C included in the image data a. The character identifying unit 151 identifies an outline of the images included in the image data a and compares the identified outline with the predetermined character to convert the images into a character. Here, the character identifying unit 151 may be provided to read a text or an image. While reading the image, the character identifying unit 151 selects a word of an object corresponding to the image from database containing a plurality of images and corresponding words, such that the voice data b can be generated depending on the selected word. The character identifying unit 151 may be an optical character reader (OCR).

The text-voice data converting unit 153 converts the character identified in the character identifying unit 151 into the voice data b. The text-voice data converting unit 153 can be provided through a text-to-speech algorithm. Here, the voice data b converted through the voice data generating unit 150 may be generated as an audio file such as an X.wav, and an X.mp3. The generated voice data b is stored in the information storing unit 140.

Meanwhile, in a case that the voice converting information is provided as an information storing tag D included in the original document, the voice data generating unit 150 may be provided to correspond to the kind of the information storing tag D or provided with the information storing tag reader 155 to read all different kinds of the information storing tag D. For example, if the information storing unit D is provided as the RFID tag, the information storing tag reader 155 includes an RFID reader capable of reading the RFID tag. The RFID reader reads the voice data b stored in the RFID tag and stores the voice data b in the information storing unit 140. Here, if the information stored in the RFID tag is a character or image information, the information is converted into the voice data b in the above-described character identifying unit 151 and the text-voice data converting unit 153.

The information storing unit 140 stores the image data a generated in the scanning unit 130, and the voice data b generated in the voice data generating unit 150 to correspond to the image data a. The information storing unit 140 can store the image data a and the voice data b together or separately. The information storing unit 140 can store the image data a which is not transmitted or has been already transmitted to the external device 200 and the voice data b, and can form a data base so that the user can search the information storing unit 140 for the image data a for a fax transmission through the voice data b.

The information storing unit 140 may store the image data a received from the external device 200 through the communicating unit 180 or the image data a received from an external memory through a direct connection. Thus, the image data a generated by a host or the like as well as the image data a generated by the scanning unit 130 may be transmitted through the communicating unit 180.

The image forming unit 160 outputs the image data a to form an image onto a printing medium according to the user's selection. The image data a may be realized by ink, a developer, and an ink ribbon. The description of the image forming unit 160 will be omitted as it is the same as a configuration of a conventional image forming unit.

The voice outputting unit 170 outputs the voice data b according to a control signal of the controller 190. The voice outputting unit 170 may be a built-in speaker of the image forming apparatus 100 or a connection terminal (not illustrated) to be connected with an external speaker.

The communicating unit 180 transmits the image data a and the voice data b to the external device 200 according to the control signal of the controller 190. The communicating unit 180 transmits the image data a, the voice data b, or both the image data a and the voice data b to the external device 200 according to a predetermined protocol method. The communicating unit 180 can be connected with the external device 200 through a modem or a LAN cable. At this time, if the communicating unit 180 is connected through the modem, the voice data b can be transmitted to the external device 200 through a telephone. When the communicating unit 180 receives the image data a and the voice data b from the external device 200, the controller 190 can control the image forming unit 160 and the voice outputting unit 170 to generate an image and a voice to correspond to the image data a and the voice data b. The controller 190 may control the display unit 120 to display the image corresponding to the image data a. The controller 190 can also control the storing unit 140 to store the received image data a and voice data b, and/or the generated image and voice.

The controller 190 controls each of the components to generate the image data a and the voice data b according to an input signal inputted through the inputting unit 120 and to transmit the voice data b and the image data a to the external device. The controller 190 controls each of the components to perform the corresponding functions, if the fax transmission function is selected through the inputting unit 120 and a fax transmission function for the visually impaired person is additionally selected.

Here, in a case that the input signal corresponding to a visually impaired person is applied, the controller 190 controls the display unit 120 and the voice outputting unit 170 to display the fax transmitting stage through an image and notify the fax transmitting state through voice, respectively. Accordingly, the voice outputting unit 170 outputs a voice message such as “Load an original document to be scanned,” and “Input the selection of a fax transmission,” to guide the user each of the stages.

The controller 190 controls the voice data generating unit 150 to convert the voice converting information of the image data a into the voice data b if the original document to be fax-transmitted is scanned in the scanning unit 130 and the image data a is generated. Also, the controller 190 controls the voice outputting unit 170 to output the converted voice data b. Also, if the voice data b included in the image data a is output through the voice outputting unit 170, the controller 190 confirms whether the voice data b is the document that the user has desired to fax-transmit through the inputting unit 110 by the user. Also, the controller 190 is inputted with whether the image data a will be transmitted or not by the user.

If the transmission signal with respect to the image data a is input through the inputting unit 110, the controller 190 controls the communicating unit 180 to transmit the image data a to the external device 200. Also, after determining whether the communicating unit 180 has transmitted the image data a, the controller 190 controls the display unit 120 to display the result of the transmission of the image data a. Also, the controller 190 can control the display unit 120 to output the state of the transmission completion through a voice message and enable the user to identify the transmission.

Meanwhile, the controller 190 controls the voice data generating unit 150 to generate the voice data b corresponding to the image data a if the recipient who receives the image data a is inputted as a visually impaired person. Also, the controller 190 controls the communicating unit 180 to transmit the voice data b and the image data a to the external device 200. At this time, the controller 190 can control the communicating unit 180 to transmit both the voice data b and the image data a to the external device 200 or sequentially transmit the voice data b and the image data a according to the selection of the recipient's receiving approval.

That is, the controller 190 can transmit the voice data b and the image data a together to the external device 200 without determining whether the user has received it or not.

Also, the controller 190 can control the communicating unit 180 to first transmit the voice data b to the external device 200 and transmit the image data a if the visually impaired recipient asks the image data a to transmit after confirming whether the data as the image data a is what he has desired to receive in response to the voice of the voice data b. In this case, the controller 190 communicates with the recipient through the communicating unit 180 to inform the recipient of the contents of the voice data b and confirms whether the recipient will receive the voice data b or not. For example, in a case that the original document of FIG. 2 is scanned and transmitted, a voice such as “A document including the contents of the Korean national anthem of the East Sea and the Mt. Baekdu will be transmitted from an exchange number XXX-XXXX. Will you receive it? If you want to, please press a transmission button,” is informed through the telephone and whether to receive it or not may be confirmed. Here, the recipient's determination of whether to receive or not is input through the inputting panels or the voice message through the telephone.

Also, the controller 190 may control the voice data generating unit 150 to generate the voice data b according to user's selection when the image data a is fax-received from the external device 200 through the communicating unit 180. In other words, the controller 190 generates the voice data b based on the image data a received through the communicating unit 180 and outputs the voice data b through the voice outputting unit 170 if a user sets a fax reception environment as the “voice attachment,” the “fax transmission mode for visually impaired person,” etc. Further, the controller 190 controls the image forming unit 160 to output the image data a to a printing medium when a user hears the voice data b and select the fax reception.

Further, the controller 190 controls the voice outputting unit 170 to output the voice data b when the voice data b is received from the external device 200. At this time, the controller 190 may control the communicating unit 180 to receive the image data a only when a user requests the output of the image data a corresponding to the voice data b.

Here, the visually impaired person includes a blind person who has lost a visual power, an elderly person, a person who has a weak visual power, and an ordinary person who needs glasses but does not temporarily have the glasses to read the image corresponding to the image data a. Also, “fax transmission for visually impaired person” written in the inputting unit 120 is taken as an example, and an expression such as “voice attachment mode” can be used.

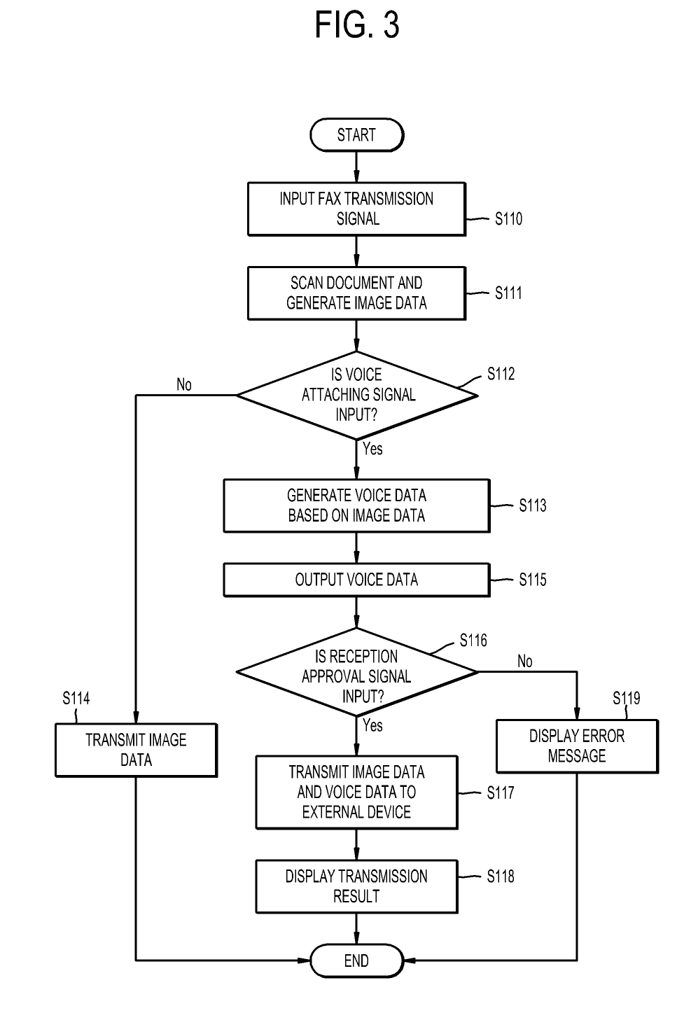

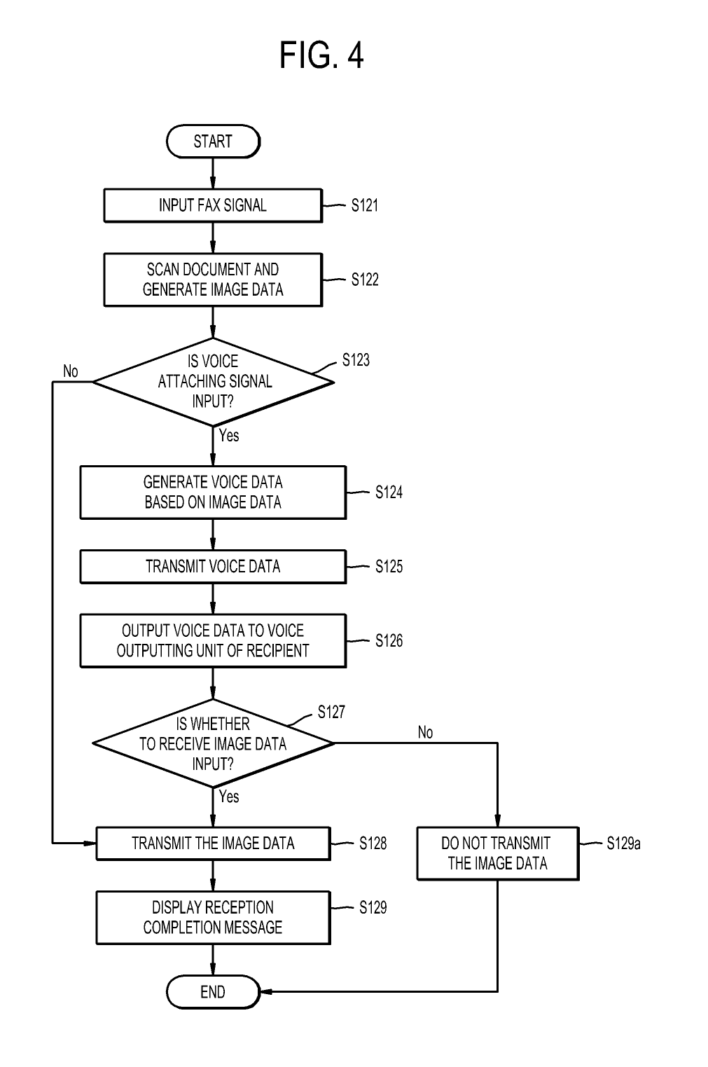

A fax transmitting process of an image forming apparatus 100 according to an embodiment of the present general inventive concept will be described by referring to FIGS. 3 and 4. FIG. 3 illustrates a case in which a user is a visually impaired person to transmit an image to an external device.

Referring to FIGS. 1, 2, and 3, if the fax transmission signal is inputted through the inputting unit 110, a fax number of the reception fax device 200 is inputted at operation S110. Also, the scanning unit 130 scans the original document and generates the image data a at operation S111. Here, the original document is supposed to be the same as that in FIG. 2 for convenience sake.

At this time, the controller 190 determines whether the user inputs a voice attaching signal for the visually impaired person at operation S112, and transmits the generated image data to the external device 200 if the voice attaching signal is not inputted at operation S114. On the other hand, if the voice attaching signal is inputted, the voice data generating unit 150 converts the voice data b on the basis of the image data a at operation S113. Also, the voice outputting unit 170 outputs the generated voice data b at operation S115. At this time, the voice outputting unit 170 can output the voice data b such as “a document including the Korean national anthem of the East Sea and the Mt. Baekdu has been scanned. Will you transmit the document?”

The user determines whether the outputted voice data b includes the contents which the user wants to transmit to the external device 200, e.g., the reception facsimile apparatus 200, and inputs the selection of the transmission of the image data a at operation S116. At this time, if the contents included in the voice data b is not a portion of the contents of the document which the user wants to transmit, the user selects a cancel button and the display unit 120 can display an error message at operation S119. It is possible that the voice outputting unit 170 may generate a voice corresponding to the error message instead of displaying the error message on the display unit 120.

On the other hand, if the document is the image data a which the user wants to transmit, the user selects the transmission button and the communicating unit 180 transmits the image data a to the external device 200 at operation S117. Also, the display unit 120 displays the transmission result of the image data at operation S118. At this time, the external device may be an image forming apparatus or a host apparatus. It is possible that the voice outputting unit 170 may generate a voice corresponding to the transmission result instead of displaying the transmission result on the display unit 120.

As described above, since the image forming apparatus 100 according to the present embodiment outputs a portion of the contents of the scanned document as voice data b before sending the image data a of the scanned document, the user can easily identify whether the document is what he/she wanted.

FIG. 4 is a flow diagram illustrating a case in which a recipient of an external device is a visually impaired person to receive the image from the image forming apparatus 100 performing a fax transmission according to an embodiment of the present general inventive concept.

Referring to FIGS. 1, 2, 3, and 4, if the user inputs a fax signal at operation S121, the scanning unit 120 scans an original document and generates the image data a at operation S122. Also, the scanning unit 120 determines whether a voice attaching signal for the visually impaired person is inputted at operation S123 and transmits the generated image data a to the reception fax device 200 at operation S128 if the voice attaching signal is not applied.

However, if the voice attaching signal for the visible impaired person is inputted at operation S123, the voice data b is generated on the basis of the image data at operation S124. Also, the converted voice data b is informed to the recipient through the telephone at operation S125. For example, the voice data b such as “the document including the Korean national anthem the East Sea and the Mt. Baekdu will be transmitted. Will you receive the document?” is outputted at operation S126. The recipient hears the voice data b and determines whether to receive or not at operation S127. That is, if the document is what the recipient wants to receive from the transmitter, the recipient presses a reception button to receive the image data a at operation S128. Also, the display unit 120 displays a reception completion message that the image data is completely transmitted to the external device 200 at operation S129.

On the other hand, if the document is not what the recipient wants to receive, the image data is not transmitted to the reception fax, an error message is displayed on the display unit 120 at operation S129a. Also, the transmitted image data and the voice data can be stored in the information storing unit 140 according to the user's desire.

As described above, the image forming apparatus according to the present general inventive concept can enable a visually impaired recipient to hear some of the contents included in the document through a voice data in advance and can receive the data after determining whether to receive or not.

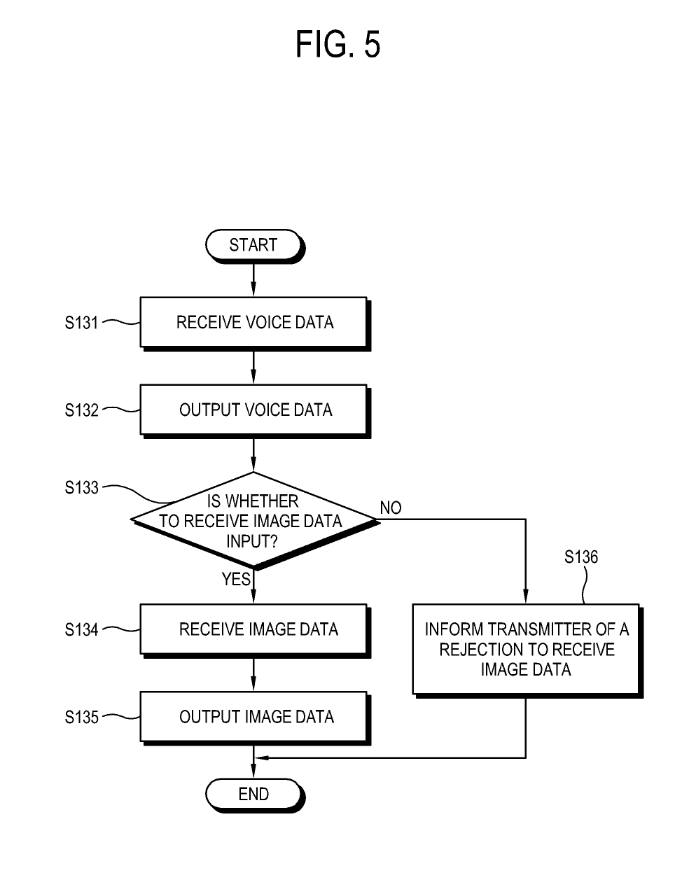

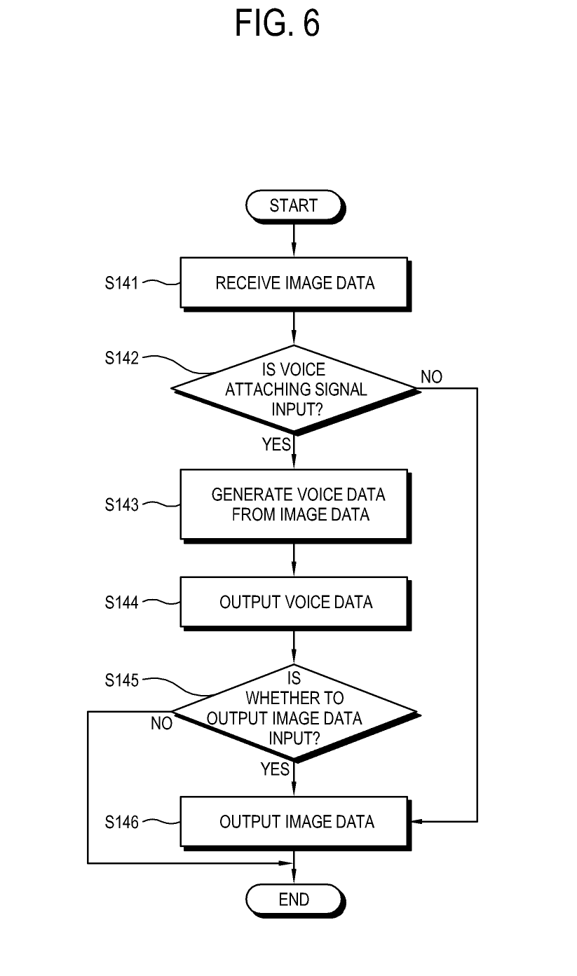

FIGS. 5 and 6 are flow diagrams illustrating a fax receiving method of an image forming apparatus according to an embodiment of the present general inventive concept. FIG. 5 illustrates the method of receiving image data in the image forming apparatus when voice data is transmitted from an external device.

Referring to FIGS. 1, 2, and 5, when the voice data b is received at operation S131, the voice data b is output through the voice outputting unit 170 and a telephone at operation S132. A user who hears the voice data inputs whether to receive the image data a including the voice data b at operation S133. If the voice data b includes the contents of the image data a which a user wants to receive, the user inputs a reception approving signal and receives the image data a from the external device 200 at operation S134. Then, the received image data a is output to the printing medium through the image forming unit 160 at operation S135. Here, the received voice data b and the received image data a may be stored in the information storing unit 140. On the other hand, if the voice data b does not correspond to the image data which a user wants to receive, the user sends a reception refusal signal to the transmitter at operation S136.

FIG. 6 shows an image forming method of an image forming apparatus when image data a is received from an external device.

Referring to FIGS. 1, 2, and 6, when the image data a is received from the external device 200 at operation S141, it is determined whether the voice attaching signal is input at operation S142. The voice attaching signal may be set as a default value at an initial environment setting or set every time when the image data a is received. If the voice attaching signal is input, the voice data generating unit 150 generates the voice data b on the basis of the received image data a at operation S143.

Then, the generated voice data b is output through the voice outputting unit 170 at operation S144, and a user determines whether the image data a is what the user has desired to receive, and inputs whether to output the image data to the printing medium at operation S145. If a user inputs an output signal, the image forming unit 160 outputs the image data a onto the printing medium at operation S146. On the other hand, if a user inputs no output signal, the image data a may be what another user has desired to receive, so that it is stored in the storage unit 140.

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

As described above, the image forming apparatus according to the present general inventive concept converts at least a portion of the contents included in the document into voice data for the visually impaired person and a user or a recipient can hear the data before sending out the image data of the document, and accordingly the user or the recipient can identify whether the document is what the user has wanted to transmit or receive by fax.

Also, an image data which is not transmitted or has been transmitted is stored in the storing unit, thereby reducing a searching time as the image data is searched later.

Although a few exemplary embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An image forming method of an image forming apparatus, the method comprising:
generating voice data based on image data according to a voice attaching signal; and
transmitting at least one of the image data and the voice data to an external device.

2. The image forming method of claim 1, further comprising:
scanning a document to generate the image data.

3. The image forming method of claim 1, further comprising:
outputting the generated voice data; and
receiving an input in response to the output voice data to transmit the image data corresponding to the voice data.

4. The image forming method of claim 1, further comprising:
transmitting the voice data to the external device through a modem; and
receiving an input from the external device to indicate whether the external device receives the image data corresponding to the voice data.

5. An image forming method of an image forming apparatus, the method comprising:
outputting voice data if the voice data is received from an external device;
receiving an input to indicate whether to receive image data corresponding to the voice data; and
receiving the image data if a reception approval signal for the image data is input, and outputting the image data to a printing medium.

6. An image forming method of an image forming apparatus, the method comprising:
generating voice data based on image data received from an external device if an voice output signal is input;
outputting the generated voice data and receiving an input to indicate whether to output the image data; and
outputting the image data to a printing medium if an output approval signal for the image data is input.

7. An image forming apparatus comprising:
a voice data generating unit to generate voice data based on image data;
a voice outputting unit to output the voice data;
an image forming unit to output the image data to a printing medium;
a communicating unit to communicate with an external device; and
a controller to generate the voice data based on the image data when a voice attaching signal is applied, and to control the communicating unit to transmit at least one of the image data and the voice data to the external device.

8. The image forming apparatus of claim 7, further comprising:
a scanning unit which scans a document and generates image data,
wherein the image data comprises one of data generated by the scanning unit and data received through the communicating unit.

9. The image forming apparatus of claim 7, wherein the voice data generating unit converts a text or at least partial area of an image, which is contained in the image data, into the voice data.

10. The image forming apparatus of claim 9, wherein the voice data generating unit comprises a character identifying unit to identify the text or the image, and a text-voice converting unit to convert the text or the image identified in the character identifying unit into the voice data.

11. The image forming apparatus of claim 8, wherein
the document comprises the information storing tag containing voice information; and
the voice data generating unit reads the information storing tag to generate the voice data.

12. The image forming apparatus according to claim 11, wherein the information storing tag comprises at least one of an RFID tag, a smart chip and an EPROM.

13. The image forming apparatus according to claim 7, wherein the controller controls the voice outputting unit to output the voice data generated by the voice data generating unit, and receives an input to indicate whether to transmit the image data corresponding to the voice data.

14. The image forming apparatus of claim 13, wherein
the communicating unit comprises a modem; and
the controller transmits the voice data to the external device through the modem and receives an input from the external device about whether the external device receives the image data corresponding to the voice data.

15. The image forming apparatus of claim 13, wherein the controller controls the communicating unit to transmit the image data and the voice data to the external device when receives a transmission approval signal for the image data.

16. The image forming apparatus of claim 7, wherein the controller outputs the voice data through the voice outputting unit when receives the voice data from the external device, and receives an input about whether to receive the image data corresponding to the voice data.

17. The image forming apparatus of claim 16, wherein, when the image data is received from the external device, the controller controls the voice data generating unit and the voice outputting unit to generate the voice data based on the image data and to output the voice data respectively.

18. The image forming apparatus of claim 16, wherein the controller controls the image forming unit to output the received image data to the printing medium.

19. A computer-readable medium to contain computer-readable codes as a program to execute a method of an image forming apparatus, the method comprising:
generating voice data based on image data according to a voice attaching signal; and
transmitting at least one of the image data and the voice data to an external device.
